(19) United States
(12) Patent Application Publication
(10) Pub. No.: US 2026/0079379 A1
(43) Pub. Date: Mar. 19, 2026

(54) Optical Frequency Shifter

(71) Applicant: Lumos Infinitas USA Inc., Irvine, CA (US)

(72) Inventors: Yufei XING, Toronto (CA); Qi CHEN, Shanghai (CN); Dachuan WU, Aliso Viejo, CA (US); Dawei ZHENG, Irvine, CA (US)

(21) Appl. No.: 18/882,011

(22) Filed: Sep. 11, 2024

(51) Int. Cl. G02F 1/35; G02F 1/355; G02F 1/365

(52) U.S. Cl. CPC G02F 1/353; G02F 1/3556; G02F 1/365; G02F 2201/06

(57) ABSTRACT

An optical device having a frequency shifter, the frequency shifter having an optical component having a phase modulator having a silicon material substrate, a buried oxide layer disposed on the silicon material substrate, a silicon waveguide disposed on the buried oxide layer, wherein the silicon waveguide is configured to guide a light, and a pair of electrodes disposed on the silicon waveguide, wherein the phase modulator is configured to change the phase of the light passing through it, and an electronic drive circuit in electrical communication with the phase modulator such that the phase change is linearly proportional to time. The disclosed optical device is configured to provide optical frequency shifting capabilities to and be integrated within silicon photonics-based devices, wherein the disclosed optical device is configured to facilitate this frequency shifting capability while being compact and having a low cost.

### BACKGROUND OF INVENTION

### 1. Field of the Invention

The invention relates generally to optical devices and specifically to optical frequency shifting devices configured for use within silicon photonics systems.

### 2. Description of the Related Art

Generally, optical frequency shifting is a key aspect of integrated photonics, having applications in signal processing, heterodyne interferometry, optical communications, and light detection and ranging (Lidar) systems. In many optical sensing systems, including, but not limited to, Lidar systems, the signal is detected by beating a signal light and a reference light. In this scenario, an optical shift is usually applied to the signal light. This optical shift is usually applied by Acousto-Optic Modulators (AOM), which is a discrete component, and can be bulky and expensive.

Therefore, there is a need to solve the problems described above by proving a device and method for compact, inexpensive, Si-photonics integrate-able frequency shifting within an optical device.

The aspects or the problems and the associated solutions presented in this section could be or could have been pursued; they are not necessarily approaches that have been previously conceived or pursued. Therefore, unless otherwise indicated, it should not be assumed that any of the approaches presented in this section qualify as prior art merely by virtue of their presence in this section of the application.

### BRIEF INVENTION SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

Provided herein are optical frequency shifters configured for “on-chip” integration. In some embodiments, the on-chip optical frequency shifters are provided by using a ridge waveguide integrated with a PIN diode to apply a saw-tooth phase shift (versus time) to the propagating light. The effect of the frequency shift may depend on the slope direction versus time, bandwidth, and rising/falling time of the saw-tooth waveform.

In an aspect, an optical device is provided, the optical device comprising a frequency shifter, the frequency shifter having: an optical component comprising: a phase modulator having: a silicon material substrate; a buried oxide layer disposed on the silicon material substrate; a silicon waveguide disposed on the buried oxide layer, wherein the silicon waveguide is configured to guide a light; and a pair of electrodes disposed on the silicon waveguide; wherein the phase modulator is configured to change the phase of the light passing through it; and an electronic drive circuit configured to be in electrical communication with the phase modulator such that a phase change of an optical signal traveling through the frequency shifter is linearly proportional to time. Thus an advantage is that the disclosed optical device may be configured to provide a compact device for shifting the frequency of a light/signal. Another advantage is that the cost of the disclosed optical device may be less than alternative mechanisms configured to provide the same functionality. Another advantage is that the disclosed optical component is configured to be implemented into silicon photonics chips, which are exceptionally common and widespread throughout the industry.

In another aspect, an optical device is provided, the optical device comprising: a 1×2 coupler configured to split an input light into a first light beam and a second light beam; a signal arm in optical communication with the 1×2 coupler, wherein the signal arm is configured to receive the first light beam, the signal arm having: an application device in optical communication with the 1×2 coupler, wherein the first light beam is sent to the application device to obtain signal information; a reference arm in optical communication with the 1×2 coupler, wherein the reference arm is configured to receive the second light beam; a 2×2 coupler in optical communication with the signal arm and the reference arm, wherein the 2×2 coupler is configured to receive and combine the first light beam from the signal arm and the second light beam from the reference arm; and a pair of photodetectors in optical communication with the 2×2 coupler, wherein the pair of photodetectors is configured to demodulate the combined first and second light beams to receive the signal information from the application device. Thus, an advantage is that a frequency shifter, such as the hereinabove described frequency shifter, may be incorporated into the structure of the signal arm and/or the reference arm to suitably manipulate the corresponding light beam traveling through the corresponding arm. Again, an advantage is that the disclosed optical device may be configured to provide a compact device for shifting the frequency of a light/signal. Another advantage is that the cost of the disclosed optical device may be less than alternative mechanisms configured to provide the same functionality. Another advantage is that the disclosed optical components are configured to be implemented into silicon photonics chips, which are exceptionally common and widespread throughout the industry. The removal of the optical frequency shifter from

In another aspect, an optical device is provided, the optical device comprising: a 1×2 coupler configured to split an input light into a first light beam and a second light beam; a signal arm in optical communication with the 1×2 coupler, wherein the signal arm is configured to receive the first light beam, the signal arm having: a first optical switch in optical communication with the 1×2 coupler; a first sub-arm in optical communication with the first optical switch, the first sub-arm comprising: a first frequency shifter in optical communication with the first optical switch, the first frequency shifter comprising: a first optical component having: a first phase modulator comprising: a first silicon material substrate; a first buried oxide layer disposed on the first silicon material substrate; a first silicon waveguide disposed on the first buried oxide layer, wherein the first silicon waveguide is configured to guide the first light beam; and a first pair of electrodes disposed on the first silicon waveguide; wherein the first phase modulator is configured to change the phase of the first light beam passing through it; and a first electronic drive circuit configured to be in electrical communication with the first phase modulator such that the phase change of the first light beam is linearly proportional to time; and a second sub-arm in optical communication with the first optical switch, the second sub-arm comprising: a second frequency shifter in optical communication with the first optical switch, the second frequency shifter comprising: a second optical component having: a second phase modulator comprising: a second silicon material substrate; a second buried oxide layer disposed on the second silicon material substrate; a second silicon waveguide disposed on the second buried oxide layer, wherein the second silicon waveguide is configured to guide the first light beam; and a second pair of electrodes disposed on the second silicon waveguide; wherein the second phase modulator is configured to change the phase of the first light beam passing through it; and a second electronic drive circuit configured to be in electrical communication with the second phase modulator such that the phase change of the first light beam is linearly proportional to time, a second optical switch in optical communication with the first and second sub-arms, wherein the first optical switch and the second optical switch are configured to switch the first light beam between the first sub-arm and the second sub-arm; an application device in optical communication with the second optical switch, wherein the first light beam is sent to the application device to obtain signal information; a reference arm in optical communication with the 1×2 coupler, wherein the reference arm is configured to receive the second light beam; a 2×2 coupler in optical communication with the signal arm and the reference arm, wherein the 2×2 coupler is configured to receive and combine the first light beam from the signal arm and the second light beam from the reference arm; and a pair of photodetectors in optical communication with the 2×2 coupler wherein the pair of photodetectors is configured to demodulate the combined first and second light beams to receive the signal information from the application device. Again, an advantage is that the disclosed optical device may be configured to provide a compact device for shifting the frequency of a light/signal. Another advantage is that the cost of the disclosed optical device may be less than alternative mechanisms configured to provide the same functionality.

The above aspects or examples and advantages, as well as other aspects or examples and advantages, will become apparent from the ensuing description and accompanying drawings.

### BRIEF DESCRIPTION OF THE DRAWINGS

For exemplification purposes, and not for limitation purposes, aspects, embodiments or examples of the invention are illustrated in the figures of the accompanying drawings, in which:

FIG. 1A illustrates the optical component and the electronic drive circuit of an optical frequency shifter, according to an aspect.

FIG. 1B illustrates a cross-sectional view of the optical component of the optical frequency shifter of FIG. 1A, along line A-A, according to an aspect.

FIG. 1C illustrates a cross-sectional doping illustration of the optical component of the optical frequency shifter of FIG. 1A along line A-A, according to an aspect.

FIG. 2A illustrates the mode effective index variation for the silicon ridge waveguide according to the applied voltage, according to an aspect.

FIG. 2B illustrates the mode optical loss for the silicon ridge waveguide according to the applied voltage, according to an aspect.

FIG. 3A illustrates a first doping configuration of the optical component of the optical frequency shifter, wherein the doping is outside the effective mode area, according to an aspect.

FIG. 3B illustrates a second doping configuration of the optical component of the optical frequency shifter, wherein the doping is inside the effective mode area, according to an aspect.

FIG. 4 illustrates a modulation waveform utilized by the optical frequency shifter, according to an aspect.

FIGS. 5A-5D illustrate the simulated performance of the optical frequency shifter, according to an aspect.

FIG. 6 illustrates a table showing the efficiency, typical device length, and modulation bandwidth for forwarded-biased and reversely-biased driving types, according to an aspect.

FIG. 7A illustrates a schematic diagram of a first embodiment of an optical sensing system, including but not limited to a silicon photonics chip, having a singular OFS, according to an aspect.

FIG. 7B illustrates the transmission of the optical sensing system of FIG. 7A, according to the voltage, the optical sensing system including but not limited to the silicon photonics chip of FIG. 7A, according to an aspect.

FIG. 7C illustrates a schematic diagram of an alternative embodiment of the exemplary first optical sensing system of FIG. 7A, including but not limited to a silicon photonics chip, having a singular OFS, according to an aspect.

FIG. 8 illustrates a schematic diagram showing an exemplary second embodiment of an optical sensing system, including but not limited to a silicon photonics chip, having a first OFS and a second OFS, according to an aspect.

FIG. 9A is a schematic diagram showing an exemplary third embodiment of an optical sensing system, including but not limited to a silicon photonics chip, having a first OFS and a second OFS disposed within the signal arm, according to an aspect.

FIG. 9B is a schematic diagram showing an alternative embodiment of the exemplary third optical sensing system of FIG. 9A, including but not limited to a silicon photonics chip, having a first OFS and a second OFS disposed within the reference arm, according to an aspect.

### DETAILED DESCRIPTION

What follows is a description of various aspects, embodiments and/or examples in which the invention may be practiced. Reference will be made to the attached drawings, and the information included in the drawings is part of this detailed description. The aspects, embodiments and/or examples described herein are presented for exemplification purposes, and not for limitation purposes. It should be understood that structural and/or logical modifications could be made by someone of ordinary skills in the art without departing from the scope of the invention. Therefore, the scope of the invention is defined by the accompanying claims and their equivalents.

It should be understood that, for clarity of the drawings and of the specification, some or all details about some structural components or steps that are known in the art are not shown or described if they are not necessary for the invention to be understood by one of ordinary skills in the art.

“Logic” as used herein and throughout this disclosure, refers to any information having the form of instruction signals and/or data that may be applied to direct the operation of a processor. Logic may be formed from signals stored in a device memory. Software is one example of such logic. Logic may also be comprised by digital and/or analog hardware circuits, for example, hardware circuits comprising logical AND, OR, XOR, NAND, NOR, and other logical operations. Logic may be formed from combinations of software and hardware. On a network, logic may be programmed on a server, or a complex of servers. A particular logic unit is not limited to a single logical location on the network.

For the following description, it can be assumed that most correspondingly labeled elements across the figures (e.g., 102 and 302, etc.) possess the same characteristics and are subject to the same structure and function. If there is a difference between correspondingly labeled elements that is not pointed out, and this difference results in a non-corresponding structure or function of an element for a particular embodiment, example or aspect, then the conflicting description given for that particular embodiment, example or aspect shall govern.

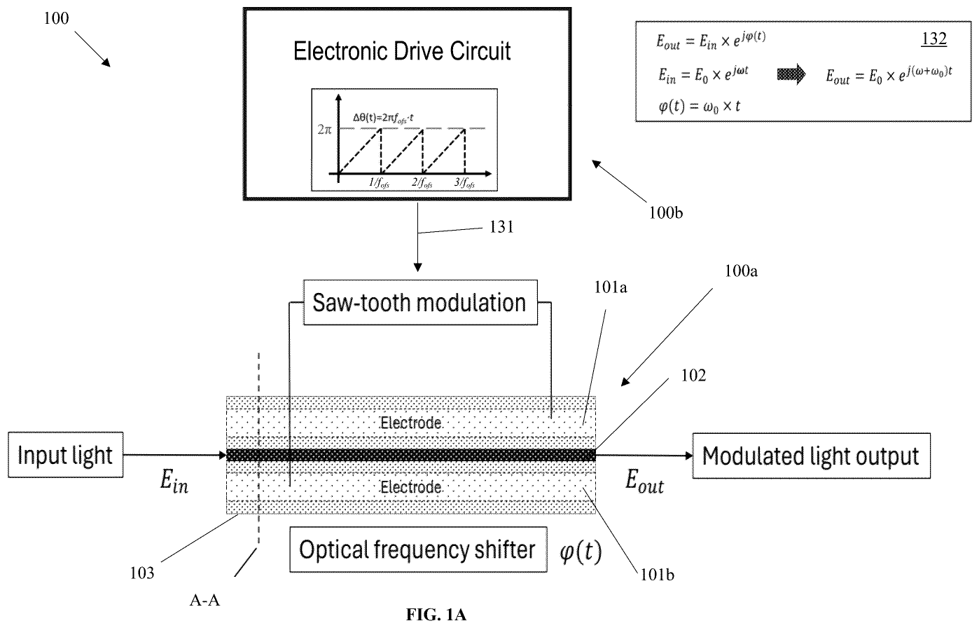

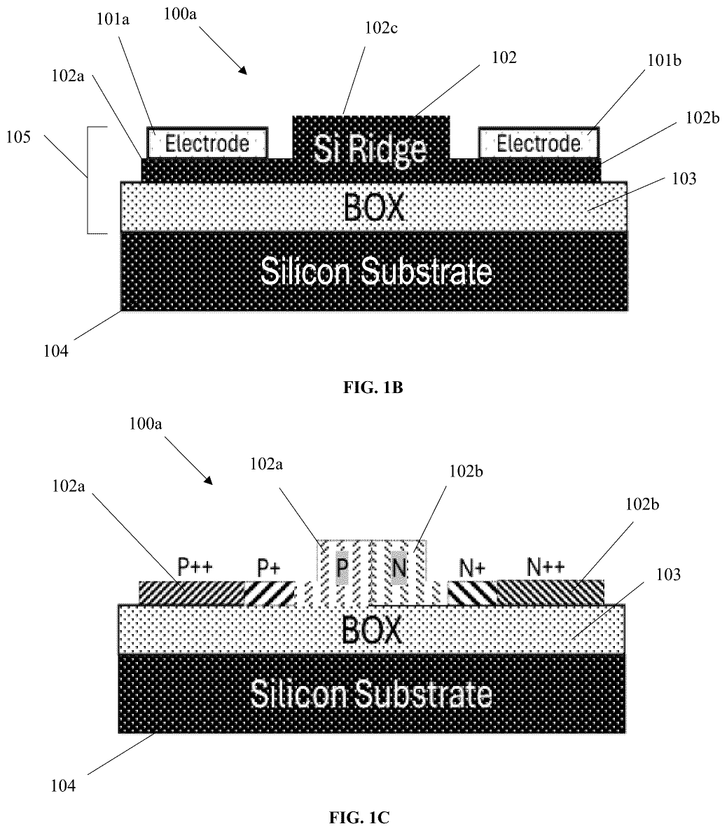

FIG. 1A illustrates the optical component 100a and the electronic drive circuit (“electrical driving circuit”, “driving circuit”, “drive circuit”) 100b of an optical frequency shifter 100, according to an aspect. FIG. 1B illustrates a cross-sectional view of the optical component 100a of the optical frequency shifter 100 of FIG. 1A along line A-A, according to an aspect. FIG. 1C illustrates a cross-sectional doping illustration of the optical component 100a of the optical frequency shifter of FIG. 1A along line A-A, according to an aspect. As described hereinabove, many optics applications require a device capable of shifting the frequency of an incoming optical signal. As can be seen in FIG. 1A, the disclosed optical component (“optical part”, “Si-Photonics integrate-able part”) 100a of the optical frequency shifter (“OFS”, “frequency shifter”) 100 may comprise a silicon substrate (“silicon material substrate”) 104 and a phase modulator 105 disposed on the silicon substrate 104, wherein the phase modulator 105 is configured to change the phase of light passing through it. In an embodiment, an OFS 100 may comprise the disclosed optical component 100a and an electronic drive circuit 100b, wherein the electronic drive circuit 100b is configured to be in electrical communication 131 with the optical component 100a of the OFS (as shown by arrow 131 of FIG. 1A). In an embodiment, the electronic drive circuit 100b may be in electrical communication with the phase modulator 105 and configured such that the phase change caused by the phase modulator 105 is linearly proportional to time.

In an embodiment, the phase modulator 105 may comprise a buried oxide (“BOX”) layer 103 disposed on the silicon substrate 104, and a silicon waveguide 102 disposed on the buried oxide layer 103. In said embodiment, silicon waveguide 102 may be a silicon ridge waveguide as seen in FIG. 1A, wherein the silicon ridge waveguide 102 comprises a raised silicon ridge 102c disposed between first and second opposing side slabs 102a, 102b. In an embodiment, phase modulator 105 may further comprise a first electrode 101a disposed on a first side slab 102a of the silicon waveguide 102 and a second electrode 101b disposed on the second side slab 102b of the silicon waveguide 102. In an embodiment, the combined structure of the silicon substrate 104, the buried oxide layer 103 and the silicon waveguide 102 may be described as a silicon-on-insulator (SOI) structure.

As can be seen in the doping diagram of FIG. 1C, the first slab area 102a of the silicon ridge waveguide 102 is doped to the p-type, and the second, opposite slab area 102b is doped to the n-type. As is understood, this particular configuration of the silicon ridge waveguide 102 results in a P-I-N diode forming inside the silicon ridge waveguide 102. It should also be noted that the positioning of the first slab area 102a and the second slab area 102b may vary depending on the direction from which the cross-section of FIG. 1C is viewed. Furthermore, it should be understood that the disclosed silicon ridge waveguide could form a P-I-N configuration or a P-N configuration, depending on the doping setup utilized.

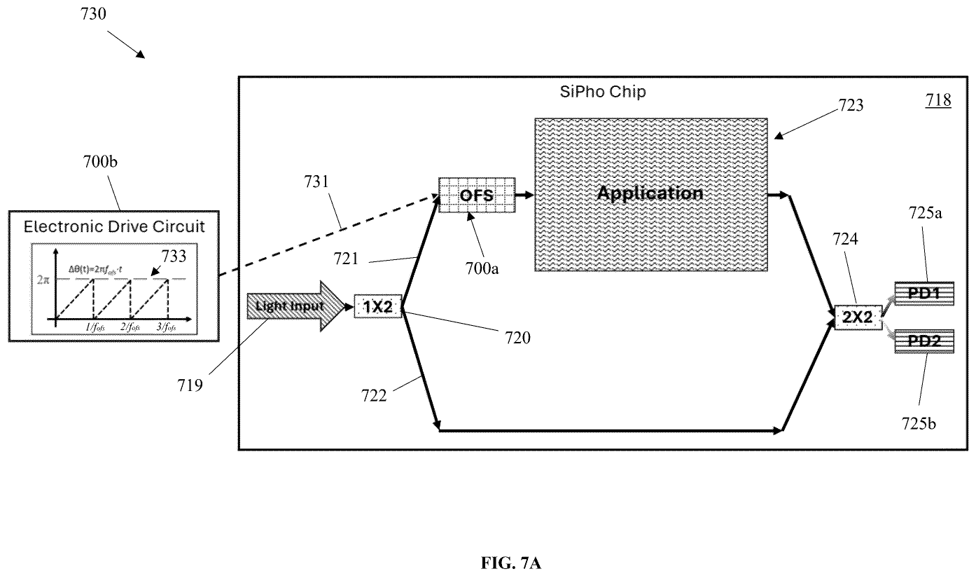

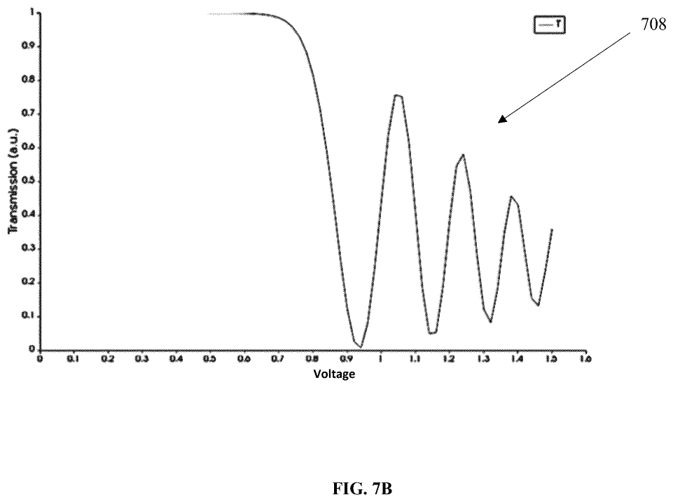

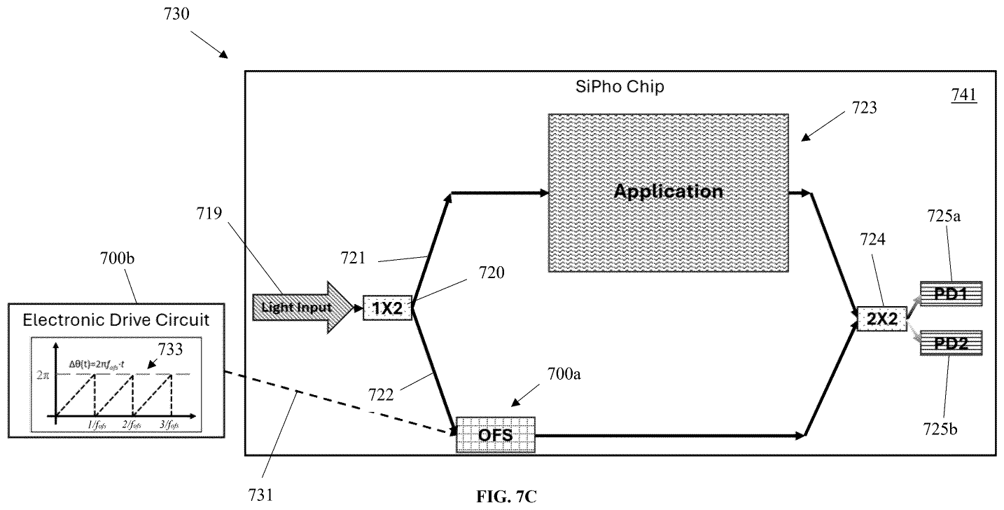

As seen in the equation box 132 of FIG. 1A, a theoretical analysis of the signal modulation for the phase of the disclosed optical component 100a may be found. As described above, the disclosed optical component 100a of the OFS 100 shown in FIG. 1A may be configured to be combined with a corresponding electronic drive circuit 100b to form an OFS 100, wherein said OFS structures are utilized in FIGS. 7A, 8 and 9, as will be described in greater detail hereinbelow. The corresponding silicon ridge waveguide 102 is configured to guide the optical mode, whereas the disclosed electronic drive circuit 100b is configured to generate a modulation signal to be applied on to the silicon ridge waveguide.

In an embodiment, the first and second electrodes 101a, 101b may be electrically connected to two pads (e.g., each electrode may be connected to a corresponding pad) through a metal layer lane and VIAs, though it should be understood that the details of the connection configuration could be different for different layouts. In an embodiment, a silicon photonics process from foundry may have 2-3 metal layers, which are normally on the top of the waveguide 102, and are separated by silicon dioxide layers, and the VIAs are the connection between different metal layers. In an embodiment, the two pads may be large rectangles on the top metal layers and could be anywhere on a silicon photonics chip (e.g., these two pads could be spatially very far away from the phase modulator 105 on the silicon photonics chip). In said embodiment, these pads are exposed to the air at the end of silicon photonics formation process, at which point they are then connected to the corresponding electronic drive circuit through metal wires (e.g. Au wires, or other suitable wires), such that the optical component 100a is electrically connected to the electronic drive circuit.

Generally, the OFSs disclosed herein are compatible with integrated silicon photonics technology. In an embodiment, the OFSs disclosed herein may be based on PIN doped silicon ridge waveguides, and thus are compatible with integrated silicon photonics technology, which is widely available. Therefore, the disclosed OFSs can be made to be very compact, and inexpensive, replacing the need for AOMs and other similar frequency shifting technologies under many application scenarios.

In an embodiment, the optical component 100a of FIG. 1A-1C may show the portion of an OFS 100 that is configured to be integrated into the structure of a silicon photonics chip, such as silicon photonics chip 718 of FIG. 7A, whereas the entirety of an OFS may comprise the disclosed optical component 100a and the electronic drive circuit 100b in electrical communication with the optical component 100a, wherein the electronic drive circuit 100b is not configured to be directly integrated into the structure of the silicon photonics chip 718. As such, the optical component 100a of the OFS 100 may be referred to as an “Si-photonics integrate-able” component/portion of the OFS 100, whereas the corresponding electronic drive circuit 100b may be referred to as an “off-chip”component/portion of the OFS 100.

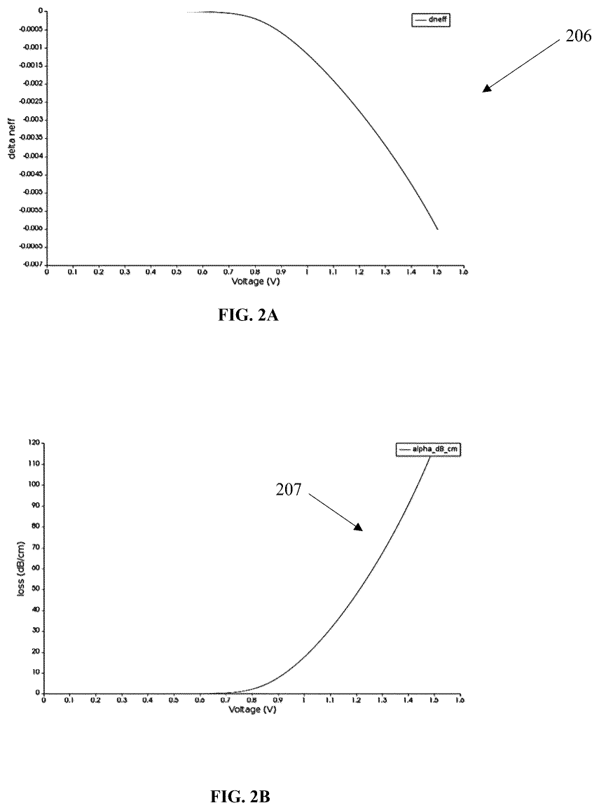

FIG. 2A illustrates the mode effective index variation 206 for the silicon ridge waveguide 102 of FIG. 1A, according to the applied voltage, according to an aspect. FIG. 2B illustrates the mode optical loss 207 for the silicon ridge waveguide of FIG. 1A, according to the applied voltage, according to an aspect. As is understood, the particular configuration of the silicon ridge waveguide 102 of FIG. 1A may result in the said silicon ridge waveguide having variable mode effective index variation and mode optical loss, wherein said attributes vary based on the applied voltage.

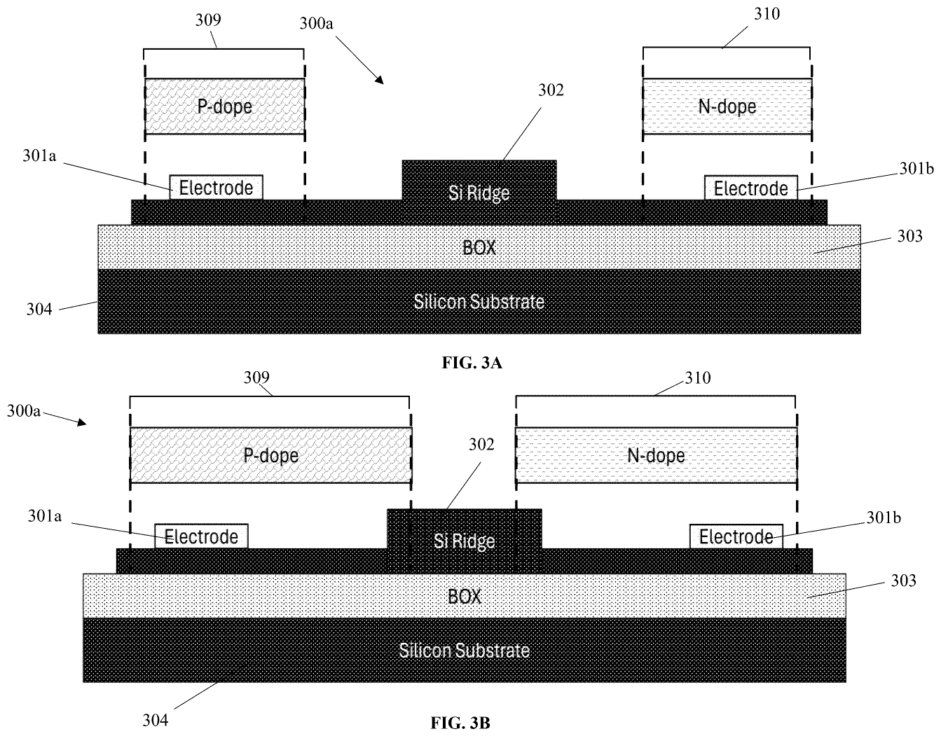

FIG. 3A illustrates a first doping configuration of the optical component 300a of the optical frequency shifter, wherein the doping is outside the effective mode area, according to an aspect. FIG. 3B illustrates a second doping configuration of the optical component 300a of the optical frequency shifter, wherein the doping is inside the effective mode area, according to an aspect. For the disclosed optical component 300a of the optical frequency shifter, it may be possible to utilize different doping configurations in order to provide different features/ advantages. A first doping configuration for the optical component 300a of the optical frequency shifter shown in FIG. 3A may comprise a p-dopant region 309 disposed within the silicon waveguide 302 beneath the first electrode 301a and n-dopant region 310 disposed within the silicon waveguide 302 beneath the second electrode 301b, wherein the dopant regions 309, 310 are outside the effective mode area. In this first configuration shown in FIG. 3A, the optical frequency shifter will operate at relatively low optical loss, but will also have a lower modulation speed and thus lower modulation bandwidth. This configuration could be applied in applications which are not so sensitive to optical efficiency, such as near range optical sensing.

A second doping configuration for the optical component 300a of the optical frequency shifter shown in FIG. 3B may comprise a p-dopant region 309 disposed within the silicon waveguide 302 beneath the first electrode 301a and n-dopant region 310 disposed within the silicon waveguide 302 beneath the second electrode 301b, wherein the dopant regions 309, 310 are inside the effective mode area. In this second configuration shown in FIG. 3B, the optical frequency shifter will operate at a relatively larger optical loss (compared to the embodiment of FIG. 3A) but will also have a larger modulation speed and thus larger modulation bandwidth. This configuration could be applied in applications which are sensitive to optical efficiency, such as long range Lidar.

As is understood, each doping configuration shown in FIG. 3A-3B may be implemented on the disclosed optical component 100a of FIG. 1A, said optical component 300a of the optical frequency shifter having the same configuration, with the silicon substrate 304, the BOX layer 303 disposed on the silicone substrate 304, the silicon ridge waveguide 302 disposed on the BOX layer 303 and the first and second electrodes 301a, 301b disposed on the silicon ridge waveguide 302.

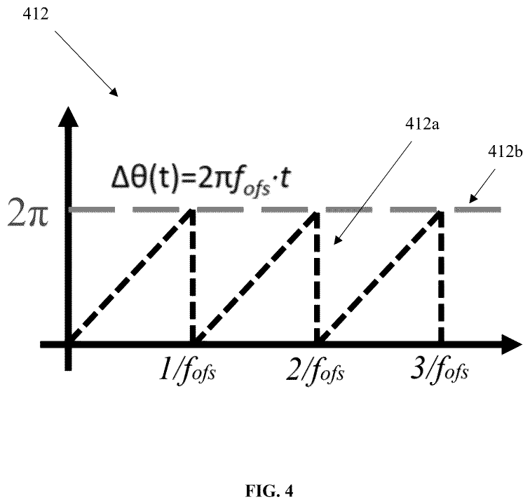

FIG. 4 illustrates the modulation signal 412 utilized by disclosed the optical phase shifter, according to an aspect. As disclosed hereinabove, the disclosed optical phase shifter, such as OFS 100 of FIG. 1A, may be configured to utilize a specific modulation signal in order to provide the desired frequency shift to an incoming optical signal. As is understood, in an embodiment, the electronic drive circuit of an OFS is the element of the OFS that is configured to generate the signal shown in FIG. 4. As can be seen in FIG. 4, this modulation signal may have a “saw-tooth” pattern 412a, the saw-tooth pattern having a linearly increasing value which drops to zero after a set duration and repeats. In FIG. 4, f_{ofs} is the frequency shifted by the OFS, such that 1/frequency is the periodicity in time. As such, 1/f_{ofs} represents the ending time of first period, 2/f_{ofs} represents the ending time for the second period and 3/f_{ofs} represents the ending time for the third period. As will be shown in greater detail hereinbelow, this modulation signal may be utilized in specific configurations to modulate an optical signal traveling through an optical device. As can be seen in FIG. 4, the maximum amplitude 412b for the shown modulation signal 412 may be 2 Pi.

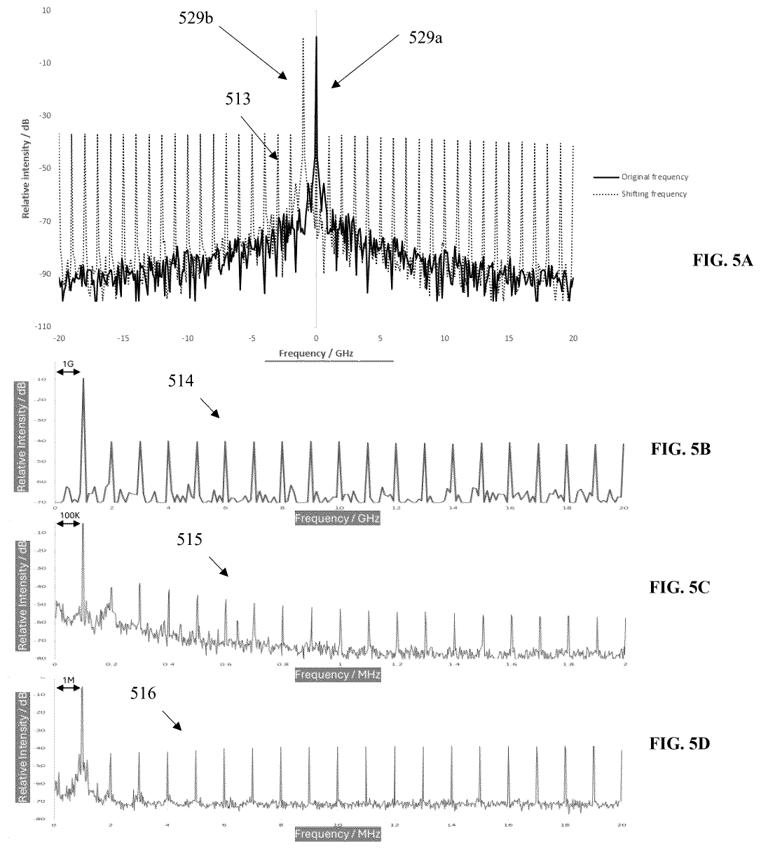

FIGS. 5A-5D illustrate the simulated performance of the optical frequency shifter, according to an aspect. Depending on the general configuration and operational parameter of an optical frequency shifter, said optical frequency shifter may be better suited or adapted for certain applications. FIG. 5A illustrates the optical spectrum of signals 513, wherein the black line 529a illustrates the original signal received by the OFS, and grey line 529b illustrates the frequency shifted signal after traveling through the OFS, wherein a 1 GHz shift occurs. FIG. 5B illustrates the electrical spectrum of a signal 514 wherein the frequency of the signal is shifted 1 GHz. FIG. 5C illustrates the electrical spectrum of a signal 515 wherein the frequency of the signal is shifted 100 KHz. FIG. 5D illustrates the electrical spectrum of a signal 516 wherein the frequency of the signal is shifted 1 MHz. It should be understood that the frequency shift generated by a corresponding optical frequency shifter may be adjusted in accordance with the needs of an application.

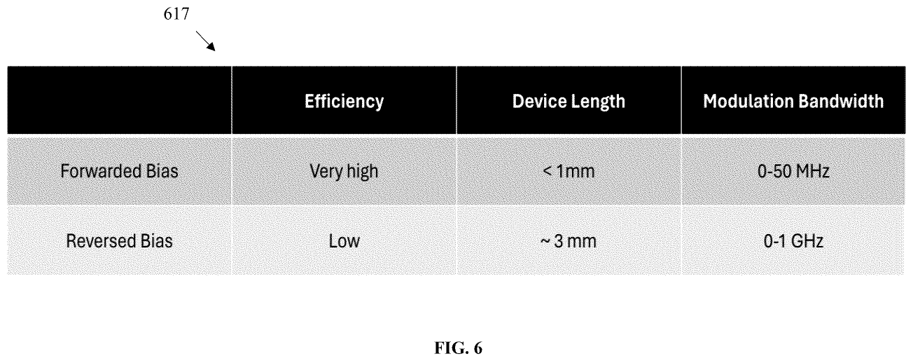

FIG. 6 illustrates a table showing the efficiency, typical device length, and modulation bandwidth for forwardly-biased and reversely-biased drive types, according to an aspect. As articulated in table 617, these two different electrical drive types may have different performance aspects that may make them better or worse suited for certain applications.

Utilizing forward bias to apply a modulation waveform onto the optical signal may be considered a more standard or conventional approach, when compared to the alternative(s). In this way, the modulation efficiency is exceptionally high, and the device could be short (<1 mm), but the modulation bandwidth is usually limited to up to 50 MHz. This forward bias approach can be used best in applications that requires only limited optical frequency shifting.

In an alternative embodiment, reverse bias may be utilized to apply modulation onto an optical signal. Through the utilization of reverse bias, one can obtain a large modulation bandwidth (up to tens of GHz) to achieve a frequency shift of approximately one to several GHz, at the cost of lower modulation efficiency and longer device length. This approach can be used best in applications which require a higher optical frequency shift, wherein the cited limitations of lower modulation efficiency and longer device length are not as important.

FIG. 7A illustrates a schematic diagram of a first embodiment of an optical sensing system (“optical device”) 730, including but not limited to a silicon photonics chip 718 having a singular OFS (“first OFS”), according to an aspect. FIG. 7B illustrates the transmission of the optical sensing system 730 of FIG. 7A, according to the voltage, the optical sensing system including but not limited to the silicon photonics chip 718 of FIG. 7A, according to an aspect. In FIG. 7A, the disclosed OFS, comprising the optical part 700a and the corresponding electronic drive circuit 700b, is configured to use a P-I-N ridge waveguide to apply a saw-tooth phase shift (versus time) to the propagation light. The effect of frequency shift depends on the slope direction versus time, bandwidth, and raising/falling time of the saw-tooth waveform. It should be noted that FIG. 7A shows a more basic implementation of the proposed OFS into silicon photonics chip system that may be expanded upon is subsequent embodiments.

In an embodiment, the silicon photonics chip 718 may comprise a light input 719 and 1×2 splitter (“1×2 coupler”) 720 in optical communication with the light input 719, a signal arm (“first arm”) 721 and a reference arm (“second arm”) 722 in optical communication with and branched from the 1×2 splitter 720. In an embodiment, the signal arm 721 may comprise a first OFS in optical communication with the 1×2 splitter 720, and an application device 723 in optical communication with the first OFS, whereas the reference arm 722 may simply be a waveguide configured to carry the corresponding received input without modifying it. As described hereinabove, the singular first OFS is configured to utilize sawtooth modulation. In an embodiment, the silicon photonics chip may further comprise a 2×2 splitter (“2×2 coupler”) 724 in optical communication with the signal arm 721 and the reference arm 722 and a first and second photodetectors (“PDs”) 725a, 725b in optical communication with and optically branched from the 2×2 splitter 724. It should be understood that the singular OFS of FIG. 7A may be referred to as a “first” OFS having a first optical part 700a and first electronic drive circuit 700b, wherein the optical part 700a of the first OFS is configured to be in optical communication with the 1×2 splitter 720 and the application device 723. Similarly, for the following descriptions, it should be understood that each element in optical communication with an OFS may be in optical communication with the optical part 700a of the OFS, wherein the optical part 700a is configured to be integrated into the corresponding silicon photonics chip 718.

In general, the OFS may usually be applied in a coherent detection system. A coherent detection system is a system that has the light from a single source (normally a DFB laser) split into two parts, which may be directed through two different optical arms (e.g., the signal arm 721 and the reference arm 722). One part of the light, which may be referred to as a “first light beam,” is sent through the signal arm 721 to the application device 723 (such as sensing or communication device) to obtain the desired signal. The other part of the light, which may be referred to as a “second light beam” is sent through the reference arm to be reserved as a reference. By comparing the first light beam from the signal arm 721 to the second light beam from the reference arm 722, the beat frequency can be detected by balanced photodetectors 725a, 725b and the signal from the application device 723 can be retrieved. This process may occur similarly for other embodiments of the silicon photonics chip disclosed herein, wherein the first light beam travels through the signal arm 721 (and thus each of its corresponding components), the second light beam travels through the reference arm 722, and both light beams are combined by a corresponding 2×2 splitter following the two arms 721, 722 for detection by the two photodetectors 725a, 725b.

As is understood, FIG. 7B illustrates the response 708 of the optical output of the phase modulator according to the applied voltage.

The basic way of applying the OFS to the silicon photonics chip 718 is integrating said optical part 700a of the OFS into the signal arm 721, and thus the beat frequency between the signal arm 721 and reference arm 722 is enlarged, becoming easier to detect. In this way, the modulation waveform 733 is a conventional saw-tooth waveform, which periodically generates 2 Pi phase change of the optical mode. As seen in FIG. 7A, the conventional sawtooth waveform 733 has a first amplitude which ramps upward with a constant positive slope over time before reaching a maximum amplitude and dropping sharply to a minimum amplitude upon reaching the ending time for the corresponding period (e.g., the waveform drops to the minimum amplitude at 1/f_{ofs}, 2/f_{ofs}, 3/f_{ofs}, etc.) As can be seen in FIG. 7A, this maximum amplitude may be 2 Pi and the minimum amplitude may be 0 for the disclosed optical sensing system embodiment.

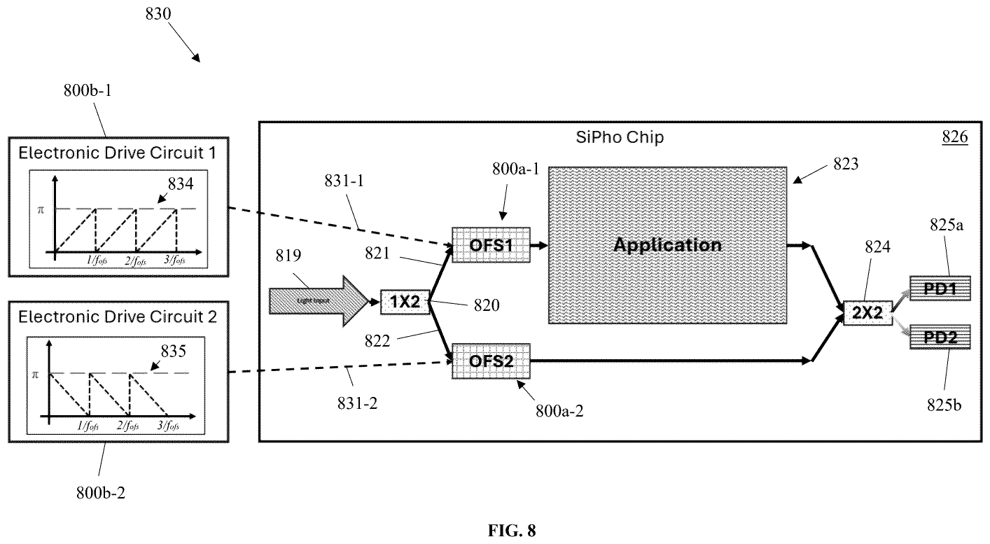

In an alternative embodiment, the modulation waveform 733 may instead be a reverse sawtooth waveform, similar to the reverse sawtooth waveform 835 of FIG. 8, wherein the reverse sawtooth waveform has a second amplitude which ramps downward with a constant negative slope over time before reaching a minimum amplitude and rising sharply to a maximum amplitude upon reaching the ending time for the corresponding period. In an embodiment, the slope of the shown conventional sawtooth waveform 733 may be the inverse of the slope of the described alternative reverse sawtooth waveform (e.g., a slope of −2 Pi/s is the inverse of a slope of 2 Pi/s). In an embodiment, the maximum and minimum amplitudes of this described reverse sawtooth waveform may be 2 Pi and 0, respectively.

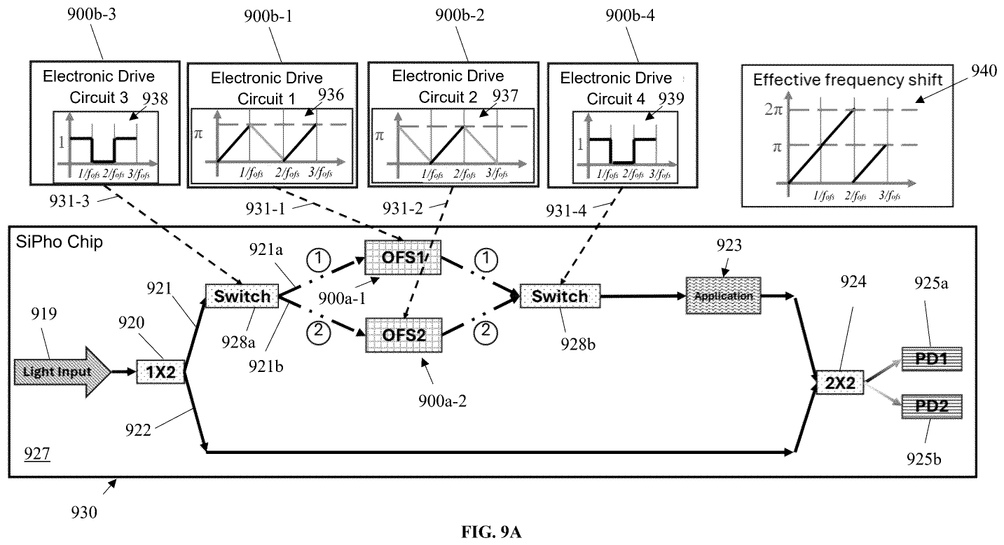

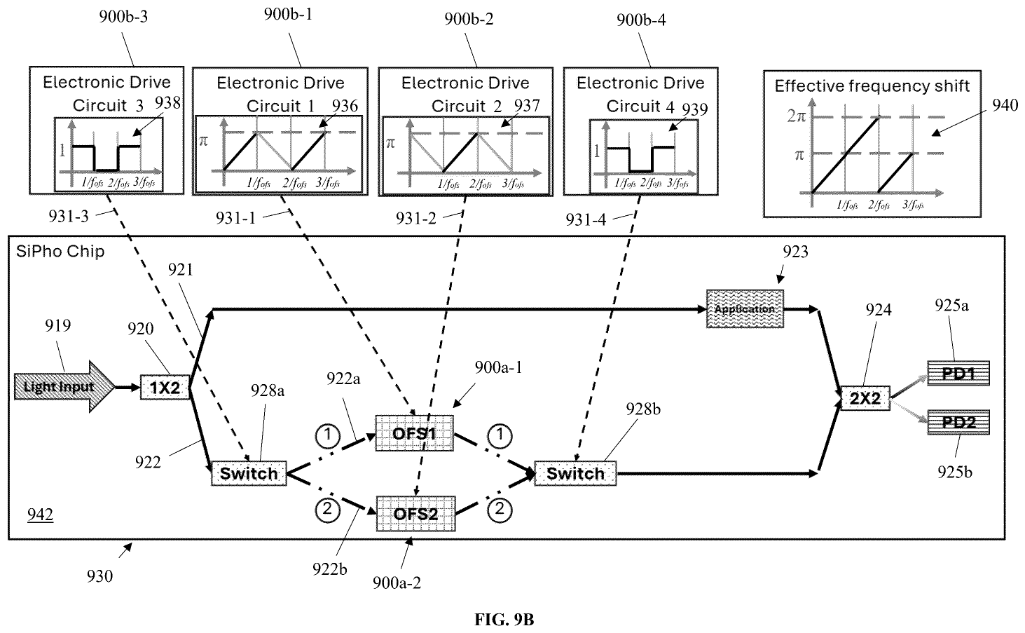

Generally, some on-chip optical frequency shifters may require or utilize a driving circuit with operating bandwidth of approximately 40× larger than intended frequency shift. This may limit the performance of the optical frequency shifter. In this embodiment, the electrical driving circuit 700b needs to have about 40 times the frequency of the modulation waveform. Various alternative embodiments are discussed herein for mitigating this limitation from the driving circuit swing amplitude. A second embodiment of FIG. 8 applies another optical frequency shift on the reference light with anti-phased modulation, and thus can half the requirement of driving voltage amplitude. A third embodiment of FIG. 9A applies an OFS on each of two sub-arms of the signal arm and uses an optical switch to switch the light between the two sub-arms, thus realizing the frequency shift by using triangular waveform, as will be discussed in greater detail hereinbelow.

As articulated hereinabove, in an embodiment, each OFS may comprise a Si-photonics integrate-able component 700a, referred to in FIG. 1A-1C as an optical part 100a of the OFS, that is configured to be integrated into the silicon photonics chip 718, as seen in FIG. 7A. In said embodiment, each OFS may further comprise an electronic drive circuit 700b, wherein said electronic drive circuit 700b is not configured to be directly integrated into the silicon photonics chip 718, as shown in FIG. 7A (e.g., the electronic drive circuit 700b is an off-chip component of the OFS), but is instead configured to be in electrical communication 731 with the optical part 700a of the OFS.

FIG. 7C illustrates a schematic diagram of an alternative embodiment of the exemplary first optical sensing system of FIG. 7A, including but not limited to a silicon photonics chip 741, having a singular OFS, according to an aspect. As can be seen in FIG. 7C, the general structure of the optical sensing system 730 of FIG. 7C is mostly the same as the optical sensing system 730 of FIG. 7A. As can be seen when comparing FIG. 7A and FIG. 7C, the positioning of the optical part 700a of the OFS within the integrated photonics chips 718, 741 may differ between corresponding embodiments. As can be seen in FIG. 7C, the disclosed optical part 700a of FIG. 7C may be disposed within the reference arm 722, rather than the signal arm 721. As such, as can be seen in FIG. 7C, the corresponding signal arm 721 may comprise the application device 723, whereas the reference arm 722 may comprise the optical part 700a. Aside from this above recited difference, the interconnections between elements of the optical sensing system 730 of FIG. 7C may be the same as those found in FIG. 7A.

For example, for the disclosed optical sensing system 730 of FIG. 7C, the optical sensing system/optical device 730 may comprise: a 1×2 coupler 720 configured to split an input light from a light input 719 into a first light beam and a second light beam; a reference arm 722 in optical communication with the 720 1×2 coupler, wherein the reference arm 722 is configured to receive the second light beam. In said embodiment of FIG. 7C, the reference arm 722 may comprise a first frequency shifter in optical communication with the 1×2 coupler 720 and the 2×2 coupler 724, the first frequency shifter comprising: a first optical component 700a disposed between and in optical communication with the 1×2 coupler 720 and the 2×2 coupler 724, the first optical component 700a having: a first phase modulator comprising: a first silicon material substrate; a first buried oxide layer disposed on the first silicon material substrate; a first silicon waveguide disposed on the first buried oxide layer, wherein the first silicon waveguide is configured to guide the second light beam; and a first pair of electrodes disposed on the first silicon waveguide; wherein the first phase modulator is configured to change the phase of the second light beam passing through it; and a first electronic drive circuit 700b configured to be in electrical communication 731 with the first phase modulator such that the phase change of the second light beam is linearly proportional to time.

Altering the structure of FIG. 7A to move the OFS (and thus the optical part 700a) from the signal arm 721 to the reference arm 722, as seen in FIG. 7C results in several consequences. First, moving the OFS from the signal arm 721 to the reference arm 722 reduces the optical loss experienced in the signal arm 721, and increases the optical loss experienced in the reference arm 722. In many sensor applications, the signal strength in the signal arm 721 is much weaker than the signal strength in the reference arm 722, and thus moving OFS from the signal arm 721 to the reference arm 722 is beneficial under certain circumstances.

It may be preferred to have a fixed optical power in the reference arm 722 before the 2×2 coupler 724 to maximize photodetector sensitivity, which is not necessary in the signal arm 721. In order to accommodate for the presence of an OFS within the reference arm 722, an additional tuning component configured to tune the optical power within the reference arm 722 may be necessary in some embodiments, to compensate for the unknown optical loss caused by the OFS. It should be noted that regardless of the position of the optical part 700a of the OFS or the type of sawtooth modulation utilized by the electronic drive circuit 700b (e.g., using a convention sawtooth waveform or a reverse sawtooth waveform), the disclosed optical sensing systems 730 of FIGS. 7A, 7C may be configured to provide the desired result of enlarging the beat frequency between signal and reference arms 721, 722.

FIG. 8 illustrates a schematic diagram showing an exemplary second embodiment of an optical sensing system 830, including but not limited to a silicon photonics chip 826, having a first OFS and a second OFS, according to an aspect. When compared to the silicon photonics chip 718 of FIG. 7, the disclosed silicon photonics chip 826 of FIG. 8 may utilize a different configuration for applying the proposed optical frequency shifter in an optical sensing system. In this proposed embodiment of FIG. 8, optical phase shifting is applied to corresponding signals/light beams on both a signal arm 821 and a reference arm 822 in an optical sensing system 830, with anti-phased modulation waveforms, to achieve the same effective optical frequency shifting with half of the modulator driving voltage swing, compared to the case of applying frequency shifting only on signal arm, as seen in FIG. 7A. In other words, the first frequency shifter (which comprises a first optical part 800a-1 and a first electronic drive circuit 800b-1 in electrical communication with the first optical part) is configured to modulate a first light beam (e.g., the light beam traveling through the signal arm 821) with a conventional saw-tooth waveform having a first amplitude and first modulation slope whereas the second frequency shifter (which comprises the second optical part 800a-2 and the second electronic drive circuit 800b-2) is configured to modulate a second light beam (e.g. the light beam traveling through the reference arm 822) with a reverse saw-tooth waveform having a second amplitude and second modulation slope, wherein the second modulation slope is the inverse of the first modulation slope, as seen in FIG. 8.

In an embodiment, the silicon photonics chip 826 may comprise a light input 819 and 1×2 splitter 820 in optical communication with the light input 819, a signal arm 821 and a reference arm 822 in optical communication with and branched from the 1×2 splitter 820. The signal arm 821 may comprise a first OFS, wherein the first OFS is in optical communication with the 1×2 splitter 820, and an application device 823 in optical communication with the first OFS, whereas the reference arm 822 may comprise a second OFS in optical communication with the 1×2 splitter 820. In an embodiment, the silicon photonics chip 826 may further comprise a 2×2 splitter 824 in optical communication with the signal arm 821 and the reference arm 822 and a first and second photodetectors 825a, 825b in optical communication with and optically branched from the 2×2 splitter 824.

As articulated hereinabove, it should be understood that the first optical part 800a-1 of the first OFS may be in optical communication with the 1×2 splitter 820 and the application device 823, whereas the first electronic drive circuit 800b-1 of the first OFS may not be integrated into the silicon photonics chip 826, but may be configured to be in electrical communication 831-1 with the first optical part 800a-1 of the first OFS. Similarly, it should be understood that the second optical part 800a-2 of the second OFS may be in optical communication with the 1×2 splitter 820 and the 2×2 splitter 824, whereas the second electronic drive circuit 800b-2 of the second OFS may not be integrated into the silicon photonics chip 826, but may be configured to be in electrical communication 831-2 with the second optical part 800a-2 of the second OFS. In an embodiment, the first optical part 800a-1 of the first OFS and the second optical part 800a-2 of the second OFS may both be configured to be integrated into the silicon photonics chip 826 to enable optical communication between OFSs and the other elements on the silicon photonics chip 826, as described above.

In an embodiment, the silicon photonics chip 826 of FIG. 8 may be configured to utilize differential saw-tooth modulation, wherein the modulation “direction” (e.g., slope) of the modulation signals applied to the light traveling through the signal arm 821 and the reference arm 822 arms are opposite, as shown in FIG. 8, so that in this way, each saw-tooth waveform only needs to periodically generate one Pi phase change of the optical mode. As such, the operating requirements of each electronic drive circuit 800b-1, 800b-2 are halved, but at the expense of requiring a second OFS. This being said, the electronic drive circuits 800b-1, 800b-2 of the OFSs still need to have a bandwidth around 40 times the frequency of the modulation waveform in the silicon photonics chip embodiment 826 of FIG. 8.

As described hereinabove, as seen in FIG. 8, the first electronic drive circuit 800b-1 may be configured to modulate an incoming signal using a conventional sawtooth waveform 834, wherein said conventional sawtooth waveform 834 has a first amplitude which ramps upward with a constant positive slope over time before reaching a maximum amplitude and dropping sharply to a minimum amplitude upon reaching the ending time for the corresponding period. In contrast, the second electronic drive circuit 800b-2 may be configured to modulate an incoming signal using a reverse sawtooth waveform 835, wherein said reverse sawtooth waveform 835 has a second amplitude which ramps downward with a constant negative slope over time before reaching a minimum amplitude and rising sharply to a maximum amplitude upon reaching the ending time for the corresponding period. In an embodiment, the conventional sawtooth waveform 834 and the reverse sawtooth waveform 835 utilized for modulation in FIG. 8 may be configured such that the sum of their amplitudes at a given time is the 1 Pi, the maximum amplitude present on each waveform 834, 835. In an embodiment, the slope of the conventional sawtooth waveform 834 may be the inverse of the slope of the reverse sawtooth waveform 835 (e.g., a slope of −2 Pi/s is the inverse of a slope of 2 Pi/s). As can be seen for each sawtooth waveform 834, 835 in FIG. 8, this maximum amplitude may be 1 Pi and the minimum amplitude may be 0 for the disclosed optical sensing system embodiment.

In an alternative embodiment, the first electronic drive circuit 800b-1 may be configured to modulate an incoming signal using a reverse sawtooth waveform (such as reverse sawtooth waveform 835), wherein said reverse sawtooth waveform has a second amplitude which ramps downward with a constant negative slope over time before reaching a minimum amplitude and rising sharply to a maximum amplitude upon reaching the ending time for the corresponding period. In said alternative embodiment, the second electronic drive circuit 800b-2 may be configured to modulate an incoming signal using a conventional sawtooth waveform (such as conventional sawtooth waveform 834), wherein said conventional sawtooth waveform has a first amplitude which ramps upward with a constant positive slope over time before reaching a maximum amplitude and dropping sharply to a minimum amplitude upon reaching the ending time for the corresponding period. As long as the first and second electronic drive circuits 800b-1, 800b-2 utilize inverse modulation waveforms (such as conventional sawtooth and reverse sawtooth waveforms) the desired optical device functionality may be achieved.

In embodiments having more than one OFS, it should be understood that specific designations may be used to differentiate the OFSs and their corresponding components. For example, a first OFS may have a first phase modulator, first silicon substrates, first electronic drive circuit 800b-1, etc., whereas a second OFS may have a second phase modulator, a second silicon substrate, a second electronic drive circuit 800b-2, etc. In an embodiment, the optical component 700a, 800a-1, 800a-2, 900a-1, 900a-2 of each OFS identified in FIGS. 7A, 8 and 9 may have the same elements as the optical component 100a described in FIG. 1A.

FIG. 9A is a schematic diagram showing an exemplary third embodiment of an optical sensing system 930, including but not limited to a silicon photonics chip 927, having a first OFS and a second OFS disposed within the signal arm 921, according to an aspect. As can be seen in FIG. 9A, the disclosed configuration of the silicon photonics chip 927 utilizes optical switches 928a, 928b along with the disclosed optical frequency shifters, using triangular waveforms 936, 937 for modulation of the received signal. In this proposed embodiment, optical phase shifting is applied on two sub-arms 921a, 921b of the signal arm 921, along with optical switches 928a, 928b to switch the light between the two sub-arms 921a, 921b, thus achieving the same effective optical frequency shifting by applying a triangular modulation waveform, when compared with applying phase shift on the signal arm by saw-tooth modulation waveforms, as described hereinabove.

In an embodiment, the silicon photonics chip 927 may comprise a light input 919 and 1×2 splitter 920 in optical communication with the light input 919, a signal arm 921 and a reference arm 922 in optical communication with and branched from the 1×2 splitter 920. The signal arm 921 may comprise a first switch (“first optical switch”) 928a in optical communication with the 1×2 splitter 920, a pair of sub arms 921a, 921b in optical communication with the first switch 928a, a second switch in optical communication with the two sub arms 921a, 921b and an application device 923 in optical communication with the second switch (“second optical switch”) 928b. A first sub arm 921a of the two sub arms may comprise a first OFS, whereas a second sub arm 921b of two sub arms may comprise a second OFS. As is understood, the first OFS may comprise a first optical part 900a-1 and a first electronic drive circuit 900b-1 configured to be in electrical communication 931-1 with the first optical part 900a-1, wherein the first optical part 900a-1 is configured to be integrated into the silicon photonics chip 927 and is in optical communication with the first and second switches 928a, 928b. Similarly, the second OFS may comprise a second optical part 900a-2 and a second electronic drive circuit 900b-2 configured to be in electrical communication 931-2 with the second optical part 900a-1, wherein the second optical part 900a-2 is configured to be integrated into the silicon photonics chip 927 and is in optical communication with the first and second switches 928a, 928b. In an embodiment, the silicon photonics chip 927 may further comprise a 2×2 splitter 924 in optical communication with the signal arm 921 and the reference arm 922 and a first and second photodetectors 925a, 925b in optical communication with and optically branched from the 2×2 splitter 924.

In an embodiment, the optical sensing system 930 may further comprise a third electronic drive circuit 900b-3 configured to be in electrical communication 931-3 with the first optical switch 928a and a fourth electronic drive circuit 900b-4 configured to be in electrical communication 931-4 with the second optical switch 928b. The third and fourth electronic drive circuits 900b-3, 900b-4 may be configured to operate the first and second optical switches 928a, 928b, respectively, using corresponding square waveform signals 938, 939, respectively, (as shown in FIG. 9A) in order to correctly switch which of the two sub arms 921a, 921b the incoming signal light travel through, and thus which optical part 900a-1, 900a-2 of a corresponding OFS the signal light travels through.

The hereinabove described configuration of the silicon photonics chip 927 may have two OFSs within the signal arm 921, and use two optical switches 928a, 928b to switch between the two OFSs. In this way, the modulation waveform can be a triangular waveform 936, 937, wherein by correctly switching between two, the signal light (first light beam) traveling through the signal arm 921 always undergoes an upward modulation, so the result could be equivalent to saw-tooth modulation. Through this particular silicon photonics chip configuration of FIG. 9A, the disclosed silicon photonics chip 927 is configured to significantly reduce the bandwidth requirement of the electrical driving circuit, but with a cost of requiring two OFSs plus two optical switches 928a, 928b.

In an embodiment, as seen in FIG. 9A, the first electronic drive circuit 900b-1 may modulate the first light beam using a first triangular waveform 936 having a first slope and a first amplitude and the second electronic drive circuit 900b-2 may modulate the first light beam using a second triangular waveform 937 having a second slope and a second amplitude. As is understood, each triangular waveform 936, 937 may be defined by a repeating pattern of having a positive slope until reaching a maximum amplitude and then changing to a negative slope until reaching a minimum amplitude, which then repeats. In an embodiment, the first slope of the first triangular waveform 936 may always be the inverse of the second slope of the second triangular waveform 937, as can be seen in FIG. 9A. Furthermore, in said embodiment, when the first amplitude is maximized, the second amplitude will be minimized, and vice versa. When utilized in conjunction with the described optical switches 928a, 928b, the effective frequency shift 940 of FIG. 9A is achieved, which is applied to the corresponding first light beam traveling through the signal arm. It should be understood that the triangular waveforms 936, 937, utilized by the first and second electronic drive circuits 900b-1, 900b-2 may be swapped, such that the first electronic drive circuit 900b-1 utilizes the second triangular waveform 937, and the second electronic drive circuit 900b-2 utilizes the first triangular waveform 936, without negatively influencing the function or capabilities of the corresponding optical device 930.

FIG. 9B is a schematic diagram showing an alternative embodiment of the exemplary third optical sensing system of FIG. 9A, including but not limited to a silicon photonics chip 942, having a first OFS and a second OFS disposed within the reference arm 922, according to an aspect. In contrast to optical device 930 of FIG. 9A, for the optical device 930 of FIG. 9B, the first and second optical parts 900a-1, 900a-2 of the first and second OFSs and the first and second optical switches 928a, 928b may be disposed within the reference arm 922. The general interconnection and interaction between the optical parts 900a-1, 900a-2 and the optical switches 928a, 928b may however remain unchanged. Furthermore, unless otherwise mentioned, the structure and arrangement of elements in the optical sensing system 930 of FIG. 9B may be the same as those described hereinabove in the optical sensing system 930 of FIG. 9A.

For example, as seen in FIG. 9B, the reference arm 922 may comprise: a first optical switch 928a in optical communication with the 1×2 coupler 920; a first sub-arm 922a in optical communication with the first optical switch 928a, the first sub-arm 922a comprising: a first frequency shifter in optical communication with the first optical switch 928a, the first frequency shifter comprising: a first optical component 900a-1 having: a first phase modulator comprising: a first silicon material substrate; a first buried oxide layer disposed on the first silicon material substrate; a first silicon waveguide disposed on the first buried oxide layer, wherein the first silicon waveguide is configured to guide the second light beam; and a first pair of electrodes disposed on the first silicon waveguide; wherein the first phase modulator is configured to change the phase of the second light beam passing through it; and a first electronic drive circuit 900b-1 configured to be in electrical communication 931-1 with the first phase modulator such that the phase change of the second light beam is linearly proportional to time; and a second sub-arm 922b in optical communication with the first optical switch 928a, the second sub-arm 922b comprising: a second frequency shifter in optical communication with the first optical switch 928a, the second frequency shifter comprising: a second optical component 900a-2 having: a second phase modulator comprising: a second silicon material substrate; a second buried oxide layer disposed on the second silicon material substrate; a second silicon waveguide disposed on the second buried oxide layer, wherein the second silicon waveguide is configured to guide the second light beam; and a second pair of electrodes disposed on the second silicon waveguide; wherein the second phase modulator is configured to change the phase of the second light beam passing through it; and a second electronic drive circuit 900b-2 configured to be in electrical communication 931-2 with the second phase modulator such that the phase change of the second light beam is linearly proportional to time; and a second optical switch 928b in optical communication with the first and second sub-arms 922a, 922b, wherein the first optical switch 928a and the second optical switch 928b are configured to switch the second light beam between the first sub-arm 922a and the second sub-arm 922b. As can be seen in FIG. 9B, unlike the optical device embodiment of FIG. 9A, each sub-arm 922a, 922b may be disposed within the reference arm 922, rather than the signal arm 921.

Similarly to the discussion hereinabove regarding the optical devices of FIGS. 7A and 7C, the alteration of the corresponding optical devices to move elements between the signal and reference arms 921, 922 may result in certain consequences. By moving the optical switches 928a, 928b and optical parts 900a-1, 900a-2 of the optical device 930a of FIG. 9A from the signal arm 921 to the reference arm 922, as seen in FIG. 9B, the optical loss experienced within the signal arm 921 may be decreased and the optical loss experienced within the reference arm 922 may be increased, as each optical switch 928a, 928b and each optical part 900a-1, 900a-2 introduce optical loss into their corresponding arm.

As described hereinabove, it is usually preferable to have a fixed optical power in the reference arm 922 before the 2×2 coupler 924 to maximize photodetector sensitivity. In order to accommodate for the presence of each OFS and optical switch 928a, 928b within the reference arm 922, an additional tuning component configured to tune the optical power within the reference arm 922 may be necessary in some embodiments, to compensate for the unknown optical loss caused by the OFSs and optical switches 928a, 928b. It should be noted that regardless of the position of the optical parts 900a-1, 900a-2 of the OFS and switches 928a, 928b, or the specific modulation utilized by the corresponding electronic drive circuits 900b-1, 900b-2. the disclosed optical sensing systems 930 of FIGS. 9A, 9B may be configured to provide the desired result of enlarging the beat frequency between signal and reference arms 921, 922.

Depending on the specific needs of an application, a user may select one of the disclosed optical devices/silicon photonics chips, such as the silicon photonic chips 718, 741 826, 927, 942 of FIGS. 7A, 7C, 8, 9A and 9B, respectively. The silicon photonics chips 718, 741 of FIGS. 7A and 7C, respectively, may have greater simplicity and reduced cost when compared to other disclosed silicon photonics chip embodiments. The silicon photonics chip 826 of FIG. 8 may have the advantage of having the same effective optical frequency shifting as silicon chips 718, 741 of FIGS. 7A, 7 Cm but with half of the modulator driving voltage swing, at the expense of silicon photonics chip 826 having increased financial cost and complexity when compared to the silicon photonics chips 718, 741 of FIGS. 7A, 7C. The silicon photonic chips 927, 942 of FIG. 9A-9B may have the advantage of reduced bandwidth requirement for the electrical driving circuits when compared to silicon photonics chips 718, 741, 826 of FIGS. 7A, 7C and 8, respectively, but at a greater financial cost and further increased complexity than the silicon photonics chip 826 of FIG. 8. As is understood, a user may select one (or more) of the disclosed silicon photonics chips described herein for a device, depending on their desired balance of performance and cost, amongst other factors.

It may be advantageous to set forth definitions of certain words and phrases used in this patent document. The term “couple” and its derivatives refer to any direct or indirect communication between two or more elements, whether or not those elements are in physical contact with one another. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Further, as used in this application, “plurality” means two or more. A “set” of items may include one or more of such items. Whether in the written description or the claims, the terms “comprising,” “including,” “carrying,” “having,” “containing,” “involving,” and the like are to be understood to be open-ended, i.e., to mean including but not limited to. Only the transitional phrases “consisting of” and “consisting essentially of,” respectively, are closed or semi-closed transitional phrases with respect to claims.

If present, use of ordinal terms such as “first,” “second,” “third,” etc., in the claims to modify a claim element does not by itself connote any priority, precedence or order of one claim element over another or the temporal order in which acts of a method are performed. These terms are used merely as labels to distinguish one claim element having a certain name from another element having a same name (but for use of the ordinal term) to distinguish the claim elements. As used in this application, “and/or” means that the listed items are alternatives, but the alternatives also include any combination of the listed items.

Throughout this description, the aspects, embodiments or examples shown should be considered as exemplars, rather than limitations on the apparatus or procedures disclosed or claimed. Although some of the examples may involve specific combinations of method acts or system elements, it should be understood that those acts and those elements may be combined in other ways to accomplish the same objectives.

Acts, elements and features discussed only in connection with one aspect, embodiment or example are not intended to be excluded from a similar role(s) in other aspects, embodiments or examples.

Aspects, embodiments or examples of the invention may be described as processes, which are usually depicted using a flowchart, a flow diagram, a structure diagram, or a block diagram. Although a flowchart may depict the operations as a sequential process, many of the operations can be performed in parallel or concurrently. In addition, the order of the operations may be re-arranged. With regard to flowcharts, it should be understood that additional and fewer steps may be taken, and the steps as shown may be combined or further refined to achieve the described methods.

If means-plus-function limitations are recited in the claims, the means are not intended to be limited to the means disclosed in this application for performing the recited function, but are intended to cover in scope any equivalent means, known now or later developed, for performing the recited function.

Claim limitations should be construed as means-plus-function limitations only if the claim recites the term “means”in association with a recited function.

If any presented, the claims directed to a method and/or process should not be limited to the performance of their steps in the order written, and one skilled in the art can readily appreciate that the sequences may be varied and still remain within the spirit and scope of the present invention.

Although aspects, embodiments and/or examples have been illustrated and described herein, someone of ordinary skills in the art will easily detect alternate of the same and/or equivalent variations, which may be capable of achieving the same results, and which may be substituted for the aspects, embodiments and/or examples illustrated and described herein, without departing from the scope of the invention. Therefore, the scope of this application is intended to cover such alternate aspects, embodiments and/or examples. Hence, the scope of the invention is defined by the accompanying claims and their equivalents. Further, each and every claim is incorporated as further disclosure into the specification.

What is claimed is:

1. An optical device comprising a frequency shifter, the frequency shifter having:
an optical component comprising:
a phase modulator having:
a silicon material substrate;
a buried oxide layer disposed on the silicon material substrate;
a silicon waveguide disposed on the buried oxide layer, wherein the silicon waveguide is configured to guide a light; and
a pair of electrodes disposed on the silicon waveguide;
wherein the phase modulator is configured to change the phase of the light passing through it; and
an electronic drive circuit configured to be in electrical communication with the phase modulator such that a phase change of an optical signal traveling through the frequency shifter is linearly proportional to time.

2. The phase modulator of claim 1, wherein the silicon waveguide is a silicon ridge waveguide, the silicon ridge waveguide comprising a first slab area doped to p-type, a second, opposite slab area doped to n-type, and a raised silicon ridge disposed between the first and second slab areas, such that a P-I-N diode is formed inside the silicon ridge waveguide.

3. The optical device of claim 1, wherein the optical component is configured to be integrated into the structure of a silicon photonics chip.

4. The optical device of claim 1, further comprising a p-dopant region disposed within the silicon waveguide beneath a first electrode of the pair of electrodes and n-dopant region disposed within the silicon waveguide beneath a second electrode of the pair of electrodes, wherein the p-dopant region and the n-dopant region are outside the effective mode area.

5. The optical device of claim 1, further comprising a p-dopant region disposed within the silicon waveguide beneath a first electrode of the pair of electrodes and n-dopant region disposed within the silicon waveguide beneath a second electrode of the pair of electrodes, wherein the p-dopant region and the n-dopant region are inside the effective mode area.

6. An optical device comprising:
a 1×2 coupler configured to split an input light into a first light beam and a second light beam;
a signal arm in optical communication with the 1×2 coupler, wherein the signal arm is configured to receive the first light beam, the signal arm having:
an application device in optical communication with the 1×2 coupler, wherein the first light beam is sent to the application device to obtain signal information;
a reference arm in optical communication with the 1×2 coupler, wherein the reference arm is configured to receive the second light beam;
a 2×2 coupler in optical communication with the signal arm and the reference arm, wherein the 2×2 coupler is configured to receive and combine the first light beam from the signal arm and the second light beam from the reference arm; and
a pair of photodetectors in optical communication with the 2×2 coupler, wherein the pair of photodetectors is configured to demodulate the combined first and second light beams to receive the signal information from the application device.

7. The reference arm of claim 6, further comprising a first frequency shifter in optical communication with the 1×2 coupler and the 2×2 coupler, the first frequency shifter comprising:
a first optical component disposed between and in optical communication with the 1×2 coupler and the 2×2 coupler, the first optical component having:
a first phase modulator comprising:
a first silicon material substrate;
a first buried oxide layer disposed on the first silicon material substrate;
a first silicon waveguide disposed on the first buried oxide layer, wherein the first silicon waveguide is configured to guide the second light beam; and
a first pair of electrodes disposed on the first silicon waveguide;
wherein the first phase modulator is configured to change the phase of the second light beam passing through it; and
a first electronic drive circuit configured to be in electrical communication with the first phase modulator such that the phase change of the second light beam is linearly proportional to time.

8. The signal arm of claim 6, further comprising a first frequency shifter in optical communication with the 1×2 coupler and the application device, the first frequency shifter comprising:
a first optical component disposed between and in optical communication with the 1×2 coupler and the application device, the first optical component having:
a first phase modulator comprising:
a first silicon material substrate;
a first buried oxide layer disposed on the first silicon material substrate;
a first silicon waveguide disposed on the first buried oxide layer, wherein the first silicon waveguide is configured to guide the first light beam; and
a first pair of electrodes disposed on the first silicon waveguide;
wherein the first phase modulator is configured to change the phase of the first light beam passing through it; and
a first electronic drive circuit configured to be in electrical communication with the first phase modulator such that the phase change of the first light beam is linearly proportional to time.

9. The optical device of claim 8, wherein the first frequency shifter is configured to modulate the first light beam with a conventional saw-tooth waveform having a first amplitude.

10. The optical device of claim 9, wherein the reference arm comprises:
a second frequency shifter in optical communication with the 1×2 coupler, the second frequency shifter comprising:
a second optical component having:
a second phase modulator comprising:
a second silicon material substrate;
a second buried oxide layer disposed on the second silicon material substrate;
a second silicon waveguide disposed on the second buried oxide layer, wherein the second silicon waveguide is configured to guide the second light beam; and
a second pair of electrodes disposed on the second silicon waveguide;
wherein the second phase modulator is configured to change the phase of the second light beam passing through it; and
a second electronic drive circuit configured to be in electrical communication with the second phase modulator such that the phase change of the second light beam is linearly proportional to time.

11. The optical device of claim 10, wherein the second frequency shifter is configured to modulate the second light beam with a reverse saw-tooth waveform having a second amplitude wherein a slope of the conventional sawtooth waveform is the inverse of a slope of the reverse sawtooth waveform.

12. The optical device of claim 8, wherein the first optical component is configured to be integrated into the structure of a silicon photonics chip.

13. The optical device of claim 10, wherein the second optical component is configured to be integrated into the structure of a silicon photonics chip.

14. The reference arm of claim 6, further comprising:
a first optical switch in optical communication with the 1×2 coupler;
a first sub-arm in optical communication with the first optical switch, the first sub-arm comprising:
a first frequency shifter in optical communication with the first optical switch, the first frequency shifter comprising:
a first optical component having:
a first phase modulator comprising:
a first silicon material substrate;
a first buried oxide layer disposed on the first silicon material substrate;
a first silicon waveguide disposed on the first buried oxide layer, wherein the first silicon waveguide is configured to guide the second light beam; and
a first pair of electrodes disposed on the first silicon waveguide;
wherein the first phase modulator is configured to change the phase of the second light beam passing through it; and
a first electronic drive circuit configured to be in electrical communication with the first phase modulator such that the phase change of the second light beam is linearly proportional to time; and
a second sub-arm in optical communication with the first optical switch, the second sub-arm comprising:
a second frequency shifter in optical communication with the first optical switch, the second frequency shifter comprising:
a second optical component having:
a second phase modulator comprising:
a second silicon material substrate;
a second buried oxide layer disposed on the second silicon material substrate;
a second silicon waveguide disposed on the second buried oxide layer, wherein the second silicon waveguide is configured to guide the second light beam; and
a second pair of electrodes disposed on the second silicon waveguide;
wherein the second phase modulator is configured to change the phase of the second light beam passing through it; and
a second electronic drive circuit configured to be in electrical communication with the second phase modulator such that the phase change of the second light beam is linearly proportional to time;
a second optical switch in optical communication with the first and second sub-arms, wherein the first optical switch and the second optical switch are configured to switch the second light beam between the first sub-arm and the second sub-arm.

15. An optical device comprising:
a 1×2 coupler configured to split an input light into a first light beam and a second light beam;
a signal arm in optical communication with the 1×2 coupler, wherein the signal arm is configured to receive the first light beam, the signal arm having:
a first optical switch in optical communication with the 1×2 coupler;
a first sub-arm in optical communication with the first optical switch, the first sub-arm comprising:
a first frequency shifter in optical communication with the first optical switch, the first frequency shifter comprising:
a first optical component having:
a first phase modulator comprising:
a first silicon material substrate;
a first buried oxide layer disposed on the first silicon material substrate;
a first silicon waveguide disposed on the first buried oxide layer, wherein the first silicon waveguide is configured to guide the first light beam; and
a first pair of electrodes disposed on the first silicon waveguide;
wherein the first phase modulator is configured to change the phase of the first light beam passing through it; and
a first electronic drive circuit configured to be in electrical communication with the first phase modulator such that the phase change of the first light beam is linearly proportional to time; and
a second sub-arm in optical communication with the first optical switch, the second sub-arm comprising:
a second frequency shifter in optical communication with the first optical switch, the second frequency shifter comprising:
a second optical component having:
a second phase modulator comprising:
a second silicon material substrate;
a second buried oxide layer disposed on the second silicon material substrate;
a second silicon waveguide disposed on the second buried oxide layer, wherein the second silicon waveguide is configured to guide the first light beam; and
a second pair of electrodes disposed on the second silicon waveguide;
wherein the second phase modulator is configured to change the phase of the first light beam passing through it; and
a second electronic drive circuit configured to be in electrical communication with the second phase modulator such that the phase change of the first light beam is linearly proportional to time;
a second optical switch in optical communication with the first and second sub-arms, wherein the first optical switch and the second optical switch are configured to switch the first light beam between the first sub-arm and the second sub-arm;
an application device in optical communication with the second optical switch, wherein the first light beam is sent to the application device to obtain signal information;
a reference arm in optical communication with the 1×2 coupler, wherein the reference arm is configured to receive the second light beam;
a 2×2 coupler in optical communication with the signal arm and the reference arm, wherein the 2×2 coupler is configured to receive and combine the first light beam from the signal arm and the second light beam from the reference arm; and
a pair of photodetectors in optical communication with the 2×2 coupler wherein the pair of photodetectors is configured to demodulate the combined first and second light beams to receive the signal information from the application device.

16. The optical device of claim 15, wherein the first frequency shifter is configured to modulate the first light beam with a triangular waveform having a first amplitude and a first slope.

17. The optical device of claim 16, wherein the second frequency shifter is configured to modulate the first light beam with a triangular waveform having a second amplitude and a second slope, wherein the first slope is the inverse of the second slope.

18. The optical device of claim 15, wherein the first optical component and the second optical component are configured to be integrated into the structure of a silicon photonics chip.

19. The optical device of claim 15, further comprising a third electronic drive circuit in electrical communication with the first optical switch and a fourth electronic drive circuit in electrical communication with the second optical switch.

20. The optical device of claim 19, wherein the third and fourth electronic drive circuits are configured to operate the first and second optical switches, respectively, using corresponding square waveform signals.
